(19) United States
(12) Patent Application Publication
(10) Pub. No.: US 2023/0133094 A1
(43) Pub. Date: May 4, 2023

(54) METHOD OF CALCULATING RANK FOR IMPORTANCE OF DATA AND APPARATUS FOR PERFORMING THE SAME

(71) Applicant: Electronics and Telecommunications Research Institute, Daejeon (KR)

(72) Inventor: Taehyoung SHIM, Sejong-si (KR)

(73) Assignee: Electronics and Telecommunications Research Institute, Daejeon (KR)

(21) Appl. No.: 17/978,686

(22) Filed: Nov. 1, 2022

(30) Foreign Application Priority Data
Nov. 3, 2021 (KR) 10-2021-0149614
Sep. 19, 2022 (KR) 10-2022-0117555

(51) Int. Cl. G06F 17/16; G06F 16/2457

(52) U.S. Cl. CPC G06F 17/16; G06F 16/24578

(57) ABSTRACT

Provided is a method of calculating a rank for importance of data and an apparatus for performing the method. An electronic device includes a memory configured to store instructions and a processor electrically connected to the memory and configured to execute the instructions, and, when the instructions are executed by the processor, the processor is configured to perform a plurality of operations, and the plurality of operations includes calculating a first matrix for a correlation between the data, calculating a second matrix for importance of the data based on the first matrix, and calculating a rank of the data based on a result of a recursive calculation on the second matrix.

### CROSS-REFERENCE TO RELATED APPLICATIONS

This application claims the benefit of Korean Patent Application No. 10-2021-0149614 filed on Nov. 3, 2021, and Korean Patent Application No. 10-2022-0117555 filed on Sep. 19, 2022, in the Korean intellectual Property Office, the entire disclosure of which is incorporated herein by reference for all purposes.

### BACKGROUND

### 1. Field of the Invention

One or more example embodiments relate to a method of calculating a rank for importance of data and an apparatus for performing the same.

### 2. Description of the Related Art

A data analysis system may be a system that analyzes data and provides various services to users based on the analysis results. The data analysis system may include sensors, a gateway, and a server. The sensors may sense various data and transmit them to the gateway. The gateway may receive, transform, and/or integrate data from the sensors, and transmit them to the server. Among the data transmitted to the server, data having a correlation may exist.

The above description is information the inventor(s) acquired during the course of conceiving the present disclosure, or already possessed at the time, and is not necessarily art publicly known before the present application was filed.

### SUMMARY

Example embodiments may calculate a rank indicating importance of data based on a correlation of the data.

Example embodiments may transmit data efficiently by transmitting the data to a server based on the rank.

However, the technical aspects are not limited to the aforementioned aspects, and other technical aspects may be present.

Additional aspects of example embodiments will be set forth in part in the description which follows and, in part, will be apparent from the description, or may be learned by practice of the disclosure.

According to example embodiments, an electronic device may include a memory configured to store instructions, and a processor electrically connected to the memory and configured to execute the instructions, and when the instructions are executed by the processor, to the processor may be configured to perform a plurality of operations, and the plurality of operations may include receiving data from a sensor, calculating a first matrix for a correlation between the data, calculating a second matrix for importance of the data based on the first matrix, and calculating a rank of the data based on a result of a recursive calculation on the second matrix.

The calculating of the second matrix may include calculating a third matrix by normalizing a row or a column of the second matrix and calculating the second matrix based on the third matrix.

The calculating of the second matrix based on the third matrix may include calculating a fourth matrix by changing a value of an element of the third matrix associated with inestimable data among the data and calculating the second matrix based on the fourth matrix, and the inestimable data may include data that may not be estimated from a rest of data except the inestimable data among the data.

The calculating of the second matrix based on the fourth matrix may include estimating a degree of a correlation between the data using information about the sensor and calculating the second matrix by weighting the fourth matrix based on the degree.

The calculating of the first matrix may include analyzing the correlation using information about the sensor and calculating an adjacency matrix for the data using the correlation.

The information may include metadata about the sensor.

The calculating of the rank may include calculating a fifth matrix satisfying a termination condition of a recursive calculation and outputting an element of the fifth matrix as a rank of the data.

The calculating of the fifth matrix may include comparing a difference between an element of a matrix of a previous stage and an element of a matrix of a current stage with a threshold value and outputting the matrix of the current stage as the fifth matrix based on a comparison result.

The plurality of operations may further include transmitting the data to a server based on the rank.

According to example embodiments, an operating method of an electronic device may include receiving data from a sensor, calculating a first matrix for a correlation between the data, calculating a second matrix for importance of the data based on the first matrix, and calculating a rank of the data based on a result of a recursive calculation on the second matrix.

The calculating of the second matrix may include calculating a third matrix by normalizing a row or a column of the second matrix and calculating the second matrix based on the third matrix.

The calculating of the second matrix based on the third matrix may include calculating a fourth matrix by changing a value of an element of the third matrix associated with inestimable data among the data, and calculating the second matrix based on the fourth matrix, and the inestimable data may include data that is not be estimated from a rest of data except the inestimable data among the data.

The calculating of the second matrix based on the fourth matrix may include estimating a degree of a correlation between the data using information about the sensor and calculating the second matrix by weighting the fourth matrix based on the degree.

The calculating of the first matrix may include analyzing the correlation using information about the sensor and calculating an adjacency matrix for the data using the correlation.

The information may include metadata about the sensor.

The calculating of the rank may include calculating a fifth matrix satisfying a termination condition of a recursive calculation and outputting an element of the fifth matrix as a rank of the data.

The calculating of the fifth matrix may include comparing a difference between an element of a matrix of a previous stage and an element of a matrix of a current stage with a threshold value and outputting the matrix of the current stage as the fifth matrix based on a comparison result.

The operating method may further include transmitting the data to a server based on the rank.

According to example embodiments, a data analysis system may include a sensor, the electronic device of claim 9 receiving data from the sensor and calculating a rank for importance of the data, and a server, and the server may include a memory configured to store instructions, and a processor electrically connected to the memory and configured to execute the instructions, and when the instructions are executed by the processor, the processor may be configured to perform a plurality of operations, and the plurality of operations may include receiving the data from the electronic device and providing a service to a user by analyzing the data.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a data analysis system according to an example embodiment;

FIG. 2 is a diagram illustrating a correlation between data according to an example embodiment:

FIG. 3 is a flowchart illustrating an operation of an electronic device according to an example embodiment;

FIG. 4 is a flowchart illustrating an operation of a server according to an example embodiment;

FIG. 5 is a schematic block diagram illustrating an electronic device according to an example embodiment; and

FIG. 6 is a schematic block diagram illustrating a server according to an example embodiment.

### DETAILED DESCRIPTION

The following structural or functional descriptions of example embodiments described herein are merely intended for the purpose of describing the example embodiments described herein and may be implemented in various forms. However, it should be understood that these example embodiments are not construed as limited to the illustrated forms.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A” or “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the example embodiments with reference to the accompanying drawings, like reference numerals refer to like elements and a repeated description related thereto will be omitted.

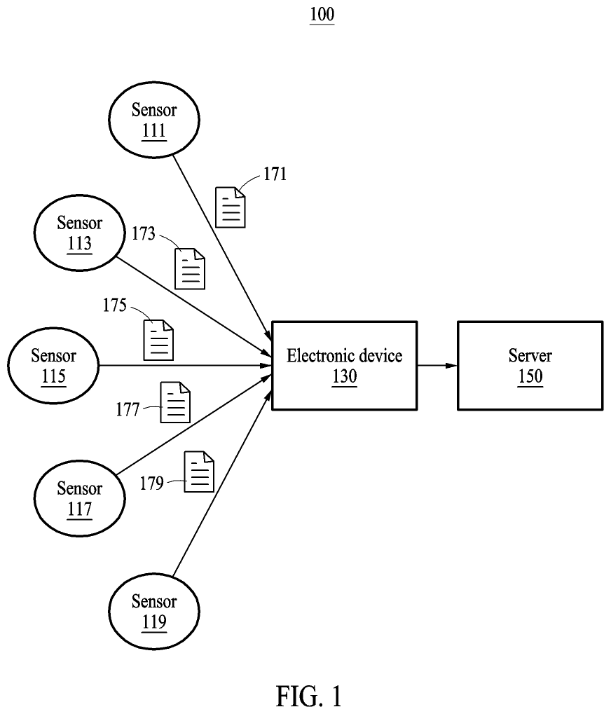

FIG. 1 is a diagram illustrating a data analysis system according to an example embodiment.

Referring to FIG. 1, according to an example embodiment, a data analysis system 100 may collect and analyze data and provide a service to a user based on an analysis result.

According to an example embodiment, the data analysis system 100 may include sensors 111 to 119, an electronic device 130 (e.g., a gateway), and/or a server 150. The number of the sensors 111 to 119 is an example for description and is not limited thereto.

According to an example embodiment, the sensors 111 to 119 may collect data 171 to 179 and transmit the data 171 to 179 to the electronic device 130. The sensors 111 to 119 may communicate with the electronic device 130 through communication such as Wireless fidelity

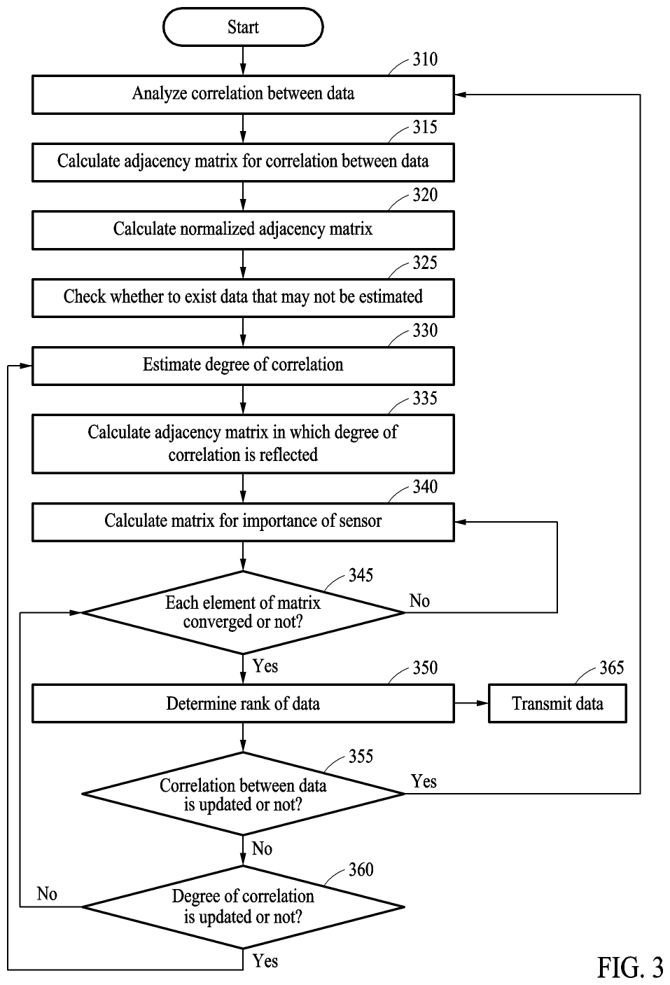

Bluetooth, Bluetooth low energy (BLE), and/or ZigBee. According to an example embodiment, the electronic device 130 may receive data 171 to 179 from the sensors 111 to 119. The electronic device 130 may analyze a correlation between the data 171 to 179 and calculate a rank for importance of the data based on the correlation. The operation of the electronic device 130 will be described in detail with reference to FIG. 3.

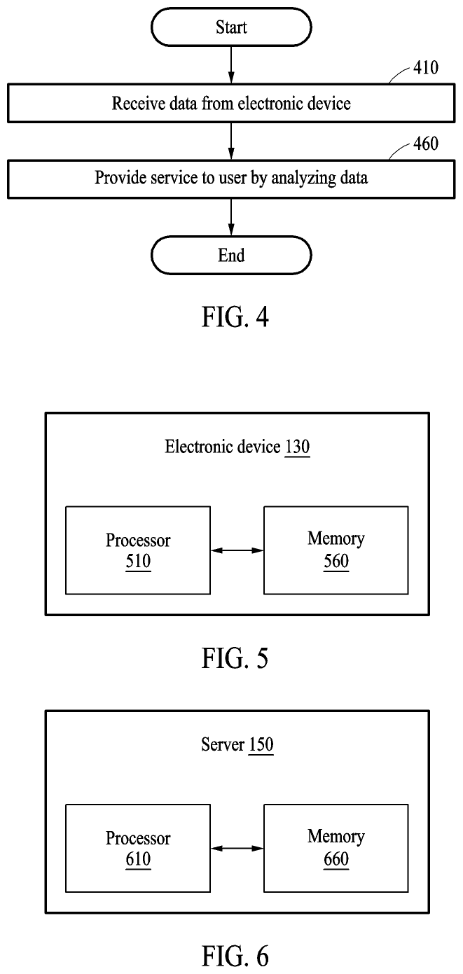

According to an example embodiment, the server 150 may receive data from the electronic device 130 and provide an analysis service to a user. The server 150 may communicate with the electronic device 130 through communication such as Wi-fi, Bluetooth, BLE, and/or ZigBee. The operation of the server 150 will be described in detail with reference to FIG. 4.

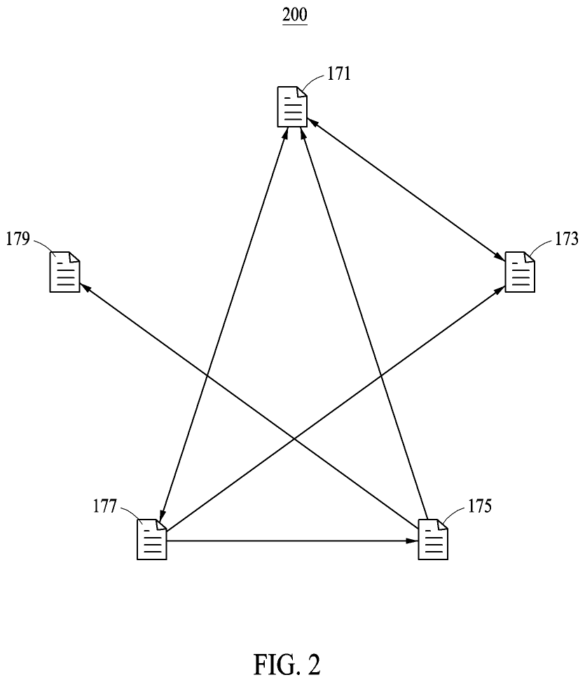

FIG. 2 is a diagram illustrating a correlation between data according to an example embodiment.

Referring to FIG. 2, according to an example embodiment, the correlation between the data 171 to 179 may indicate a similarity of the data 171 to 179. For example, when data A may be estimated from data B, it may be understood that a correlation exists between the data A and the data B. The correlation may include a first correlation and/or a second correlation.

The first correlation may include a relationship in which the first data. may be estimated from the second data, but the second data may not be estimated from the first data. The second correlation may include a relationship in which the first data may be estimated from the second data and the second data may also be estimated from the first data.

According to an example embodiment, a correlation 200 may represent an example of a correlation that may exist between the data 171 to 179.

The data 171 may have a correlation with the data 173 to 177. For example, the data 171 may be estimated from the data 173 and/or the data 177. The data 173, data 175, and/or data 177 may be estimated from the data 171.

The data 173 may have a correlation with the data 171 and the data 177. For example, the data 173 may be estimated from the data 171. The data 171 and/or the data 177 may be to estimated from the data 173.

The data 175 may have a correlation with the data 171, the data 177, and the data 179. For example, the data 175 may be estimated from the data 171 and/or the data 179. The data 177 may be estimated from the data 175.

The data 177 may have a correlation with the data 171 to 175. For example, the data 177 may be estimated from the data 171, the data 173, and/or the data 175. The data 171 may be estimated from the data 177.

The data 179 may have a correlation with the data 175. For example, the data 175 may be estimated from the data 179.

According to an example embodiment, the electronic device 130 may analyze the correlation between the data 171 to 179 and determine a rank of the data for transmission based on the correlation,

FIG. 3 is a flowchart illustrating an operation of an electronic device according to an example embodiment.

Referring to FIG. 3, according to an example embodiment, operations 310 to 360 may be sequentially performed but is not limited thereto. For example, operation 330 may be performed after operation 310, operation 315, or operation 320. Alternatively, operation 330 may be omitted. For example, two or more operations may be performed in parallel.

In operation 310, the electronic device (e.g., the electronic device 130 of FIG. 1) may analyze the correlation (e.g., the correlation 200 of: FIG. 2) between the data (e.g., the data 171 to 179 of FIGS. 1 and 2). For example, the electronic device 130 may analyze the correlation between the data 171 to 179 using information (e.g., metadata) about the sensors (e.g., the sensors 111 to 119 of FIG. 1).

In operation 315, the electronic device 130 may calculate a matrix A (e.g., an adjacency matrix) for the correlation 200 of the data 171 to 179. For example, the matrix A for the correlation 200 may be expressed as the following Equation 1.

$$A = [ \begin{matrix}0 & 1 & 1 & 1 & 0 \\ 1 & 0 & 0 & 1 & 0 \\ 0 & 0 & 0 & 1 & 0 \\ 1 & 0 & 0 & 0 & 0 \\ 0 & 0 & 1 & 0 & 0\end{matrix} ] \qquad [ Equation 1 ]$$

In matrix A, the elements of each row may be associated with other data that may be estimated from the data associated with each row, and the elements of each column may be associated with data used to estimate the data associated with each column. However, rnattix A is an example of a matrix expressing the correlation 200, and the correlation 200 may be expressed by various matrices.

In operation 320, the electronic device 130 may calculate a normalized matrix W. example, the electronic device 130 may normalize a row and/or a column of the matrix A. The normalization may be a process of weighting based on a degree of the correlation between data. For example, the normalization may be expressed as the following Equation 2.

$${W}_{j} = \frac{{w}_{kj} {A}_{j}}{{\sum }_{k = 1}^{n} {A}_{kj}} , … j = 1 , … , n \qquad [ Equation 2 ]$$

In Equation 2, Wₖⱼ may be a weight. The weight may be determined based on the number of data having the correlation with certain data and the degree of the correlation between the certain data and each data. The degree of the correlation may be estimated based on trained data. For example, since the data 173 may be estimated from the data 171, the weight may be 1. For example, since the data 173 may be estimated from the data 171, the weight may be 1. For example, when the degree of the correlation between the data 177 and each of the data 171 to 175 is the same, the weight between the data 177 and the data 171 to 175 is ⅓. When the degree of the correlation between the data 171 to 179 is the same, the column normalized matrix W may be expressed as the following Equation 3.

$$W = [ \begin{matrix}0 & 1 & \frac{1}{2} & \frac{1}{3} & 0 \\ \frac{1}{2} & 0 & 0 & \frac{1}{3} & 0 \\ 0 & 0 & 0 & \frac{1}{3} & 0 \\ \frac{1}{2} & 0 & 0 & 0 & 0 \\ 0 & 0 & \frac{1}{2} & 0 & 0\end{matrix} ] \qquad [ Equation 3 ]$$

In operation 325, the electronic device 130 may check the existence of data that may not be estimated from other data. For example, in correlation 200, the data 179 may not be estimated from other data 171 to 177. When the existence of data (e.g., the data 179) that is not be estimated from the other data is confirmed, the electronic device 130 may change a value of an element of the matrix W associated with the inestimable data 179 to a constant (e.g., 1). The matrix S in which the value of the element is changed may be expressed as the following Equation 4.

$$S = [ \begin{matrix}0 & 1 & \frac{1}{2} & \frac{1}{3} & 0 \\ \frac{1}{2} & 0 & 0 & \frac{1}{3} & 0 \\ 0 & 0 & 0 & \frac{1}{3} & 0 \\ \frac{1}{2} & 0 & 0 & 0 & 0 \\ 0 & 0 & \frac{1}{2} & 0 & 1\end{matrix} ] \qquad [ Equation 4 ]$$

In operation 330, the electronic device 130 may estimate the degree of the correlation between the data 171 to 179. For example, the electronic device 130 may calculate a weight (α) associated with the degree of the correlation by using information (e.g., metadata) about the sensors. The weight (α) may be associated with a probability (β) that each of the data 171 to 179 may be independent data that is not correlated with other data. The relationship between the weight (α) and the probability (β) may be expressed as the following Equation 5.

β=(1−α), 0≤α≤1 [Equation 5]

In operation 335, the electronic device 130 may calculate a matrix P in which the degree of the correlation is reflected. The matrix P may be calculated as the following Equation 6.

P=β×S+α×I [Equation 6]

In Equation 6, I may represent an identity matrix.

For example, the probability (β) is 0.15, the mattix P may be calculated as the following Equation 7.

$$P = [ \begin{matrix}0.15 & 0.85 & 0.425 & 0.28 \dot{3} & 0 \\ 0.425 & 0.15 & 0 & 0.28 \dot{3} & 0 \\ 0 & 0 & 0.15 & 0.28 \dot{3} & 0 \\ 0.425 & 0 & 0 & 0.15 & 0 \\ 0 & 0 & 0.425 & 0 & 1\end{matrix} ] \qquad [ Equation 1 ]$$

In operation 340, the electronic device 130 may calculate a matrix R (e.g,, a rank matrix) for importance of the sensors 111 to 119. The matrix R may be calculated based on the recursive calculation. Specifically, the matrix R may be calculated as shown in the following Equation 8.

Rₙ₊₁=P×Rₙ [Equation 8]

The initial matrix (Rₙ) may be expressed as the following Equation 9.

$$R 1 = [ \begin{matrix}1 \\ 1 \\ 1 \\ 1 \\ 1\end{matrix} ] \qquad [ Equation 9 ]$$

The table below shows a result of the recursive calculation using the matrix P (e.g., the matrix P in Equation 7).

TABLE 1

| | Data | | | | |
|---|---|---|---|---|---|
| n | Data 171 | Data 173 | Data 175 | Data 177 | Data 179 |
| 0 | 1 | 1 | 1 | 1 | 1 |
| 1 | 1.708 | 0.858 | 0.433 | 0.575 | 1.425 |
| 2 | 1.33225 | 1.017325 | 0.227675 | 0.81215 | 1.609025 |
| 3 | 1.391164 | 0.948643 | 0.26399 | 0.688029 | 1.705787 |
| 4 | 1.321929 | 0.928253 | 0.234311 | 0.694449 | 1.817982 |
| 5 | 1.283416 | 0.897587 | 0.231676 | 0.665987 | 1.917564 |
| 6 | 1.242398 | 0.868564 | 0.223226 | 0.64535 | 2.016027 |
| 7 | 1.202144 | 0.840938 | 0.216118 | 0.624822 | 2.110898 |
| 8 | 1.163793 | 0.813876 | 0.209242 | 0.604635 | 2.202748 |
| 9 | 1.126403 | 0.787805 | 0.202498 | 0.585307 | 2.291676 |
| 10 | 1.090299 | 0.762534 | 0.196017 | 0.566518 | 2.377737 |
| . . . | . . . | . . . | . . . | . . . | . . . |

Referring to Table 1, it may be seen that the importance of the data 171 to 179 is changed as the calculation is repeated.

In operation 345, the electronic device 130 may check whether an element of the matrix R converges to terminate the recursive calculation. For example, when the difference between the elements of the matrix from the previous stage (Rₙ) and the elements of the matrix from the current stage (Rₙ₊₁) is smaller than a threshold value, the electronic device 130 may terminate the recursive calculation.

In operation 350, the electronic device 130 may determine the elements of the matrix (Rₙ₊₁) from the current stage as a rank of the data 171 to 179.

In operation 355, the electronic device 130 may check whether the correlation between the data 171 to 179 is updated. When the update is confirmed, the electronic device 130 may re-analyze the correlation. The operation of checking whether the update has been made may be performed at regular intervals.

In operation 360, the electronic device 130 may check whether the degree of the correlation between the data 171 to 179 is updated. When the update is confirmed, the electronic device 130 may re-estimate the degree of the correlation. The operation of checking whether the update has been made may be performed at regular intervals.

In operation 365, the electronic device 130 may transmit the data 171 to 179 to the server (e.g., the server 150 of FIG. 1) based on the rank. For example, the electronic device 130 may transmit data having a higher rank to the server 150 with priority.

FIG. 4 is a flowchart illustrating an operation of a server according to an example embodiment.

Referring to FIG. 4, the server (e.g., the server 150 of FIG. 1) may analyze data (e.g., the data 171 to 179 of FIG. 1) and provide a service to a user based on an analysis result.

In operation 410, the server 150 may receive the data 171 to 179 from the electronic device (e.g., the electronic device 130 of FIG. 1). The data 171 to 179 may be received based on a rank indicating importance of the data.

In operation 460, the server 150 may analyze the data 171 to 179 and provide a service to a user based on an analysis result. For example, the server 150 may analyze data on facilities of a factory, an internal environment, and/or an external environment, and provide a to guide for the facility operation to a user.

FIG. 5 is a schematic block diagram illustrating an electronic device according to an example embodiment.

Referring to FIG. 5, the electronic device 130 may include a memory 560 and a processor 510.

The memory 560 may store instructions (or programs) executable by the processor 510. For example, the instructions may include instructions for executing an operation of the processor 510 and/or an operation of each component of the processor 510.

The processor 510 may process data stored in the memory 560. The processor 510 may execute a computer-readable code (e.g., software) stored in the memory 560 and instructions triggered by the processor 510.

The processor 510 may be a hardware-implemented data processing device having a circuit that is physically structured to execute desired operations. For example, the desired operations may include code or instructions included in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

An operation performed by the processor 510 may be substantially the same as those of the electronic device 130 described with reference to FIGS. 1 and 3. Accordingly, further description thereof is not repeated herein.

FIG. 6 is a schematic block diagram illustrating a server according to an example embodiment.

Referring to FIG. 6, according to an example embodiment, the server 150 may include a memory 660 and a processor 610.

The memory 560 may store instructions (or programs) executable by the processor 610. For example, the instructions may include instructions for executing an operation of the processor 610 and/or an operation of each component of the processor 610.

The processor 610 may process data stored in the memory 660. The processor 610 may execute a computer-readable code (e.g., software) stored in the memory 660 and instructions triggered by the processor 610.

The processor 610 may be a hardware-implemented data processing device having a circuit that is physically structured to execute desired operations. For example, the desired operations may include code or instructions included in a program.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

An operation performed by the processor 730 may be substantially the same as those of the system 400 described with reference to FIGS. 1 through 6. Accordingly, further description thereof is not repeated herein.

The example embodiments described herein may be implemented using a hardware component, a software component and/or a combination thereof. A processing device may be implemented using one or more of general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software.

For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, to different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, is or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program SO instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or to supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An electronic device, comprising:
a memory configured to store instructions; and.
a processor electrically connected to the memory and configured to execute the instructions,
wherein, when the instructions are executed by the processor, the processor is configured to perform a plurality of operations, and
wherein the plurality of operations comprises:
receiving data from a sensor;
calculating a first matrix for a correlation between the data;
calculating a second matrix for importance of the data based on the first matrix; and
calculating a rank of the data based on a result of a recursive calculation on the second matrix.

2. e electronic device of claim 1, wherein the calculating of the second matrix comprises:
calculating a third matrix by normalizing a row or a column of the second matrix; and
calculating the second matrix based on the third matrix.

3. The electronic device of claim 2, wherein the calculating of the second matrix based on the third matrix comprises:
calculating a fourth matrix by changing a value of an element of the third matrix associated with inestimable data among the data; and
calculating the second matrix based on the fourth matrix,
wherein the inestimable data comprises data that is not be estimated from a rest of data except the inestimable data among the data.

4. The electronic device of claim 3, wherein the calculating of the second matrix based on the fourth matrix comprises:
estimating a degree of a correlation between the data using information about the sensor; and
calculating the second matrix by weighting the fourth matrix based on the degree.

5. The deetronic device of claim 1, wherein the calculating of the first matrix comprises:
analyzing the correlation using information about the sensor; and
calculating an adjacency matrix for the data using the correlation.

6. The electronic device of claim 5, wherein the information comprises metadata about the sensor.

7. The electronic device of claim 1, wherein the calculating of the rank comprises:
calculating a fifth matrix satisfying a termination condition of a recursive calculation; and
outputting an element of the fifth matrix as a rank of the data.

8. The electronic device of claim 7, wherein the calculating of the fifth matrix comprises:
comparing a difference between an element of a matrix from a previous stage and an element of a matrix from a current stage with a threshold value; and
outputting the matrix of the current stage as the fifth matrix based on a comparison result.

9. The electronic device of claim 1, wherein the plurality of operations further comprises transmitting the data to a server based on the rank.

10. An operating method of an electronic device, the method comprising:
receiving data from a sensor;
calculating a first matrix for a correlation between the data;
calculating a second matrix for importance of the data based on the first matrix; and
calculating a rank of the data based on a result of a recursive calculation on the second matrix.

11. The method of claim 10, wherein the calculating of the second matrix comprises:
calculating a third matrix by normalizing a row or a column of the second matrix; and
calculating the second matrix based on the third matrix.

12. The method of claim 11, wherein the calculating of the second matrix based on the third matrix comprises:
calculating a fourth matrix by changing a value of an element of the third matrix associated with inestimable data among the data; and
calculating the second matrix based on the fourth matrix,
wherein the inestimable data comprises data. that is not be estimated from a rest of data except the inestimable data among the data.

13. The method of claim 12, wherein the calculating of the second matrix based on the fourth matrix comprises:
estimating a degree of a correlation between the data using information about the sensor; and
calculating the second matrix by weighting the fourth matrix based on the degree.

14. The method of claim 10, wherein the calculating of the first matrix comprises:
analyzing the correlation using information about the sensor; and
calculating an adjacency matrix for the data using the correlation.

15. The method of claim 14, wherein the information comprises metadata about the sensor.

16. The method of claim 10, wherein the calculating of the rank comprises:
calculating a fifth matrix satisfying a termination condition of a recursive calculation; and
outputting an element of the fifth matrix as a rank of the data.

17. The method of claim 16, wherein the calculating of the fifth matrix comprises:
comparing a difference between an element of a matrix from a previous stage and an elementof a matrix from a current stage with a threshold value; and
outputting the matrix of the current stage as the fifth matrix based on a comparison result.

18. The method of claim 10, further comprising:
transmitting the data to a server based on the rank.

19. A data analysis system, the system comprising:
a sensor;
the electronic device of claim 9 receiving data from the sensor and calculating a rank for importance of the data; and
a server,
wherein the server comprises:
a memory configured to store instructions; and
a processor electrically connected to the memory and configured to execute the instructions,
wherein, when the instructions are executed by the processor, the processor is configured to perform a plurality of operations, and
wherein the plurality of operations comprise:
receiving the data from the electronic device; and.
providing a service to a user by analyzing the data.
